(19) United States
(12) Patent Application Publication
(10) Pub. No.: US 2013/0315363 A1
(43) Pub. Date: Nov. 28, 2013

(54) DEVICE AND METHOD FOR REPLACING AN IRRADIATED FUEL ASSEMBLY WITH A NEW FUEL ASSEMBLY IN THE VESSEL OF A NUCLEAR REACTOR, AND NUCLEAR REACTOR INCLUDING SUCH A DEVICE

(71) Applicants: Franck Dechelette, Aix En Provence (FR); Emmanuel Sanseigne, Villeneuve (FR); Aurelien Morcillo, Aix En Provence (FR)

(72) Inventors: Franck Dechelette, Aix En Provence (FR); Emmanuel Sanseigne, Villeneuve (FR); Aurelien Morcillo, Aix En Provence (FR)

(73) Assignee: COMMISSARIAT A L'ENERGIE ATOMIQUE ET AUX ENERGIES ALTERNATIVES, Paris (FR)

(21) Appl. No.: 13/879,797

(22) PCT Filed: Aug. 31, 2011
(86) PCT No.: PCT/EP11/64949

§ 371 Date: Apr. 16, 2013

(30) Foreign Application Priority Data
Oct. 22, 2010 (FR) 1058641

(51) Int. Cl. G21C 19/19; G21C 19/18

(52) U.S. Cl. CPC G21C 19/19; G21C 19/18
USPC 376/264

(57) ABSTRACT

A device and a method to replace an irradiated fuel assembly with a new fuel assembly in the vessel of a nuclear reactor. This device includes: means for installing the two fuel assemblies in two containers containing heat transfer fluid, where the first container is filled with the irradiated fuel assembly having just been extracted from the reactor core by a handling arm, and where the second container is filled with the new fuel assembly brought in by a transfer basket, means for positioning both these containers, where the irradiated fuel assembly is accessible by the transfer basket, whereas the new fuel assembly is in a position where it can be taken up by the handling arm, and means for positioning both the fuel assemblies.

### TECHNICAL FIELD

The invention relates to a device and a method for replacing an irradiated fuel assembly with a new fuel assembly in the vessel of a nuclear reactor, and a nuclear reactor including such a device.

In what follows, a reactor with a sodium heat transfer fluid is considered as an example. But any type of reactor with a heat transfer fluid which must not be in contact with air, and which must thus be handled under a plug (more generally under a covering aperture) is also possible.

### STATE OF THE PRIOR ART

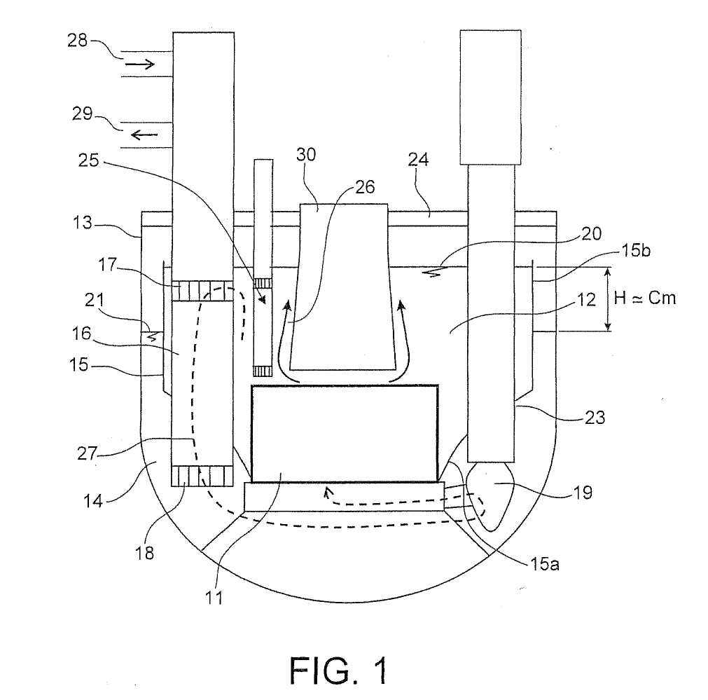

Sodium-cooled nuclear reactors (SFR) habitually include a vessel in which the core is located. A core cover plug or BCC referenced 30 in FIG. 1, located above the core, includes the instrumentation required for control and satisfactory operation of the nuclear reactions. The heat is extracted by pumping the sodium, called the primary sodium, by means of a pump system installed in the vessel. The heat is transferred to an intermediate circuit, via one or more intermediate exchanger(s), before being used to generate steam in a steam generator. This steam is then conveyed into a turbine to transform it into mechanical energy, which is in its turn transformed into electrical energy. The intermediate circuit enables the primary sodium which is in the vessel to be isolated from the steam generator, due to the violent reactions likely to occur between the sodium and the water vapour contained in the steam generator in the event of a fracture of a tube of the latter. There are thus two sodium circuits: one called the “primary” circuit, responsible for transferring the heat between the core and one of the intermediate heat exchanger(s), and the other called the “secondary” circuit, responsible for transferring the heat from the heat exchanger(s) to the steam generator. Other fluids than water/steam may be envisaged to transform the thermal energy into electrical energy.

Sodium-cooled reactors (SFR) have common technical characteristics. The vessel is sealed at the top by a covering slab in order that the primary sodium is not in contact with the outside air. All the components (exchangers, pumps, pipes, etc.) traverse this slab vertically in order that they may be disassembled and raised vertically by a lifting device, using clearance holes in this covering slab. There are two major families of such reactors: loop reactors and the reactors of integrated type. In SFR loop reactors the intermediate exchangers and the primary sodium pumping systems are located outside the vessel. Conversely, in SFR reactors of the integrated type all the intermediate exchangers and the primary sodium pumping means are located inside the vessel which, since this avoids having the primary circuit leave the vessel, constitutes a major advantage. A reactor of this type was chosen in the “SuperPhénix” reactor in France, and in the reactor planned with the name EFR or “European Fast Reactor”, as described in the document referenced [1] at the end of the description.

In an SFR reactor of the integrated type, as represented schematically in FIG. 1, the primary sodium traverses core 11 to remove the heat produced. At the outlet of core 11 the primary sodium arrives in an area 12 of vessel 13 of the reactor sealed by covering slab 24: commonly called the hot collector. This hot collector is separated from another area 14, called the cold collector, by a wall 15 which is cylindrical-conical in shape, called a redan, consisting of a lower portion 15a which surrounds core 11 and which has a general truncated cone shape, and of an upper portion 15b, which is a cylindrical portion. This intermediate exchanger 16 consists of a bundle of tubes in which the secondary sodium flows, and between which the primary sodium flows. References 28 and 29 are a secondary sodium inlet pipe and outlet pipe. In this intermediate exchanger 16, the secondary sodium enters a central tube, traverses the exchanger, and emerges at the base of the exchanger in a distribution unit, which enables all the tubes of the tube bundle to be supplied with sodium, and exits again in an outlet collector. The path followed by the primary sodium is represented schematically as a dotted line 27 in FIG. 1. The primary sodium enters into each intermediate exchanger 16 through inlet windows 17 located in the hot collector 12, transfers its heat to the secondary sodium, following the tubes of each intermediate exchanger 16, and exits from the intermediate exchanger through outlet windows 18. In the cold collector 14 the primary sodium is sucked up by pumping means 19 and conveyed directly to the inlet of core 11, which is located beneath the latter. Pumping means 19 consist of electromechanical pumps the shaft of which extends vertically appreciably throughout the height of vessel 13, and traverses covering slab 24. The sodium is made to flow in each intermediate exchanger 16 under gravity between the hot collector 12 and the cold collector 14. The driving head of the primary sodium Cm between collectors 12, 14 is calibrated to a value of approximately 2 m, corresponding to level difference H between level 20 of the hot collector 12 and level 21 of the cold collector 14. Several specific exchangers 25, which are smaller than intermediate exchangers 16, enable the core's decay power, which comes from the radioactive decay of the fission products created during the nuclear reactions when the reactor was under power (normal operation) to be removed. These exchangers 25 are activated only when the reactor is stopped, or in the event of an incident. The hydraulic path of the primary sodium consists of the hot column represented diagrammatically by solid-line arrow 26, and the cold column represented by dotted arrow 27.

A nuclear reactor is equipped with a primary vessel in which the nuclear core is located. This core consists of several hundred fuel assemblies, which are comparable to pencils of hexagonal shape, the sides of which measure 20 cm and which are approximately 4 m high.

These fuel assemblies are regularly changed, the irradiated fuel assemblies being replaced with new fuel assemblies. This fuel assembly change operation is undertaken with the reactor shut down. It is therefore essential to be as fast as possible, for the sake of the reactor's availability rate.

Although handling of the fuel assemblies is undertaken with the primary vessel open in the case of the pressurised water reactors currently forming France's nuclear generation capacity, it must be undertaken with the primary vessel closed in the case of sodium-cooled reactors, principally due to the reactivity of sodium with air.

To replace an irradiated fuel assembly of the nuclear core a set of mechanisms inserted inside the primary vessel is thus used to undertake the following operations:
extraction of the irradiated fuel assembly to be evacuated from the nuclear core,
insertion of this irradiated fuel assembly in an evacuation position,
evacuation of the irradiated fuel assembly,
arrival of a new fuel assembly,
insertion of the new fuel assembly in the primary vessel,
installation of the new fuel assembly in the nuclear core.

Systems of the known art, such as the French Phénix and Superphénix prototypes, use rotating plug systems to undertake the operations to insert/extract the nuclear core fuel assemblies. These assemblies can then be removed from the primary vessel by a system of ramps and locks. In order to improve the handling rate a rotating transfer lock may be added to the Superphénix version (tipper lock in the Phénix), in order to replace an irradiated fuel assembly by a new fuel assembly after extraction from the vessel, and by this means to undertake operations simultaneously. In the current planned sodium reactors vertical extraction/insertion of the fuel assemblies is envisaged, where the conveyance of the fuel assembly is then undertaken by a transfer basket, whilst keeping the fuel assembly in a neutral atmosphere.

To improve the availability of the reactors a rotor-based system may also be used, which enables an irradiated fuel assembly to be replaced by a new fuel assembly, and by this means enables certain operations to be undertaken simultaneously.

In the case of the EFR, the operations to transport a fuel assembly in a transfer basket from the reactor vessel to the washing or conditioning pit can be undertaken simultaneously with the operations to install and extract the fuel assembly into or from the nuclear core.

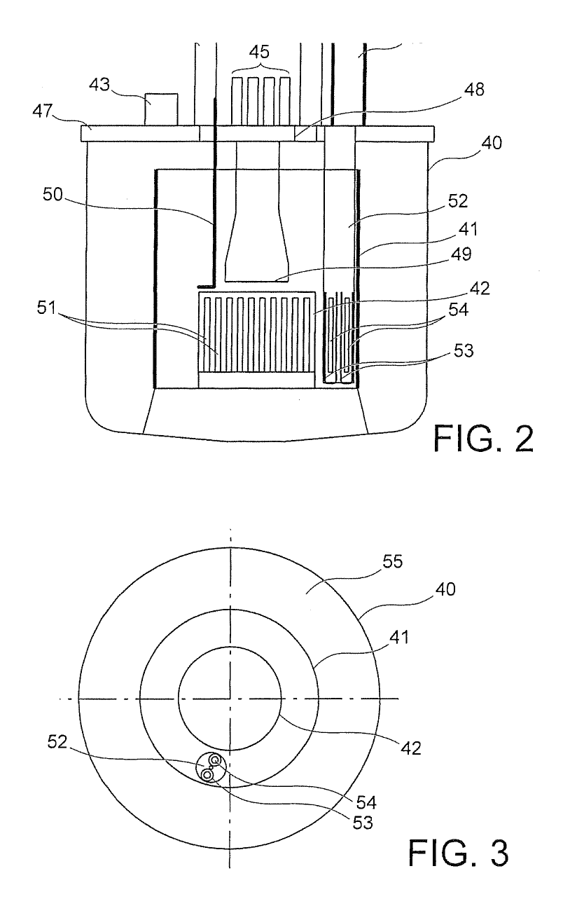

FIGS. 2 and 3 illustrate a nuclear reactor which thus includes the following previously described elements illustrated in FIG. 1:
a main vessel 40,
an internal vessel 41,
a nuclear core 42,
primary pumps 43,
intermediate exchangers 44,
control rods 45,
a transfer basket 46, including a “lift” function with the assistance of a grab, to bring in the new fuel assemblies and remove the irradiated fuel assemblies,
a covering slab 47,
a rotating plug system 48,
a core cover plug or BCC 49.

The system to assist with loading/unloading of fuel assemblies includes:
handling arm 50, enabling the new or irradiated fuel assemblies 51 to be moved in all three dimensions: radially, laterally by rotation, and vertically,
a metal handling rod, which can be moved only up and down, attached to a rotating plug, and enabling the positions of assemblies which are not accessible by handling arm 50 to be reached, and thus place this fuel assembly in a position accessible by handling arm 50,
a rotor system 52, including sodium containers 53 in which fuel assemblies 54 are positioned.

Current technological trends are tending to handle and extract the irradiated fuel assemblies at ever higher thermal power levels (of the order of 40 kW, compared to 7.5 kW in the EFR), which requires that the fuel assemblies are extracted and conveyed in sodium containers, where each assembly is brought out with a container containing sodium, guaranteeing a certain thermal inertia, and helping to cool the assembly.

Rotor system 52 is longer than in the EFR project, in order to have the clearance required to be able to insert a fuel assembly in a sodium container. The rotor system is thus positioned at a height roughly equivalent to that of the nuclear core.

Reduction of the main vessel diameter is a fundamental challenge, since it has direct consequences for the cost of the reactor, but also the installation of the rotor system inside the internal vessel has a major impact on the total diameter of the main vessel, portion 55 between the internal vessel and the main vessel being used by different components.

One object of the invention is to propose an improvement of this rotor system enabling the reactor's internal vessel diameter to be reduced, and therefore the main vessel diameter, and by this means enabling the cost of this reactor to be reduced.

### DESCRIPTION OF THE INVENTION

The invention relates to a device to replace an irradiated fuel assembly with a new fuel assembly in the vessel of a nuclear reactor, which includes:
means for installing two fuel assemblies, one irradiated and one new, in two containers containing heat transfer fluid, where the first container is filled with the irradiated fuel assembly having just been extracted from the core by a handling arm, and where the second container is filled with the new fuel assembly brought in by a transfer basket,
means for positioning both these containers, where the irradiated fuel assembly is placed in a position where it is accessible by the transfer basket, whereas the new fuel assembly is in a position where it can be taken up by the handling arm,
means for positioning both fuel assemblies, where the new fuel assembly is transported into the core, whereas the irradiated fuel assembly is transported out of the reactor, characterised in that the means for positioning the containers are means for positioning by rotation with two offset shafts accomplished by a single motor.

In one advantageous embodiment the device of the invention includes a single-piece structure the upper portion of which is surmounted by a sealed case.

This single-piece structure advantageously includes:
a parallelepipedic metal frame of lengthened shape, open in one of its lengthened faces,
two rotary shafts, one outlet chute the upper portion of which is split, and two containers in its lower portion connected to one another by a connecting rod in their lower portions.

The sealed case advantageously includes a motor with an endless screw associated with two stepped wheels, each of which is rigidly connected with one of the two shafts, enabling these two shafts to be rotated simultaneously, and a valve to close the upper portion of the outlet chute.

The heat transfer fluid is advantageously sodium.

The device of the invention enables the following advantages to be obtained:
it allows greater compactness compared to a conventional rotor system, and reduced diameter of the internal vessel, and therefore of the reactor's main vessel,
in addition, it enables the heat transfer fluid container to be accessible at the outlet by the handling arm in the event of a blockage.

The invention also relates to a nuclear reactor including a vessel able to be filled with heat transfer fluid, and within which are positioned a core, pumping means to pump the primary heat transfer fluid, first intermediate heat exchangers, able to evacuate the power produced by the core during normal operation, second residual heat exchangers able to evacuate the decay power produced by the core when shut down, when the pumping means are also stopped, and a covering slab, characterised in that it includes a device as defined above.

The reactor is advantageously a sodium heat transfer fluid reactor.

Finally, the invention relates to a method to replace an irradiated fuel assembly with a new fuel assembly in the vessel of a nuclear reactor, which includes:
a step of installing two fuel assemblies, one irradiated and one new, in two containers containing heat transfer fluid, where the first container is filled with the irradiated fuel assembly having just been extracted from the reactor core by a handling arm, and where the second container is filled with the new fuel assembly brought in by a transfer basket.
a step of positioning both these containers, where the irradiated fuel assembly is placed in a position where it is accessible by the transfer basket, whereas the new fuel assembly is in a position where it can be taken up by the handling arm.
a step of positioning both assemblies, where the new fuel assembly is brought into the core, whereas the irradiated fuel assembly is taken out of the reactor, characterised in that the step of positioning of the two containers is a step of positioning by rotation with two offset rotational shafts accomplished by a single motor.

A motor with an endless screw associated with two stepped wheels, each of which is rigidly connected with one of the two rotary shafts, is advantageously used. An outlet chute and two heat transfer fluid containers connected to one another by a connecting rod are used. The aperture of the outlet chute is closed by means of a valve. The heat transfer fluid is advantageously sodium.

### BRIEF DESCRIPTION OF THE ILLUSTRATIONS

FIG. 1 illustrates a vertical section view of a nuclear reactor with sodium heat transfer fluid of the known art.

FIGS. 2 and 3 illustrate schematically a vertical section view and a top view of a nuclear reactor with sodium heat transfer fluid of the known art including a rotor system.

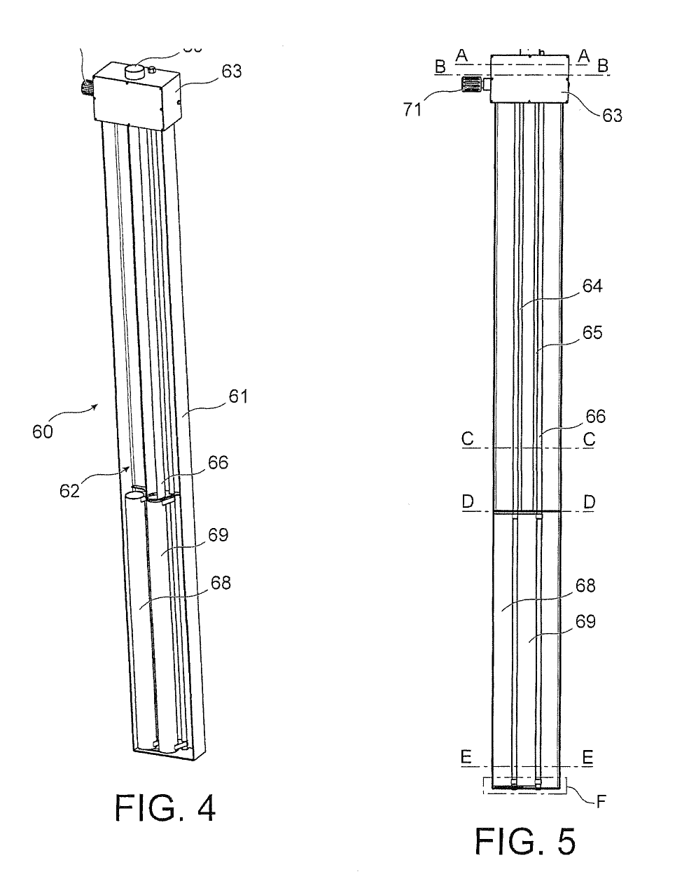

FIGS. 4 to 17 illustrate details of the device to replace an irradiated fuel assembly with a new fuel assembly in the vessel of a nuclear reactor with sodium heat transfer fluid, according to the invention, using two sodium containers, and more specifically:

FIG. 4 illustrates an isometric view of the device of the invention.

FIG. 5 illustrates a front view of the device of the invention in a first position of the two containers.

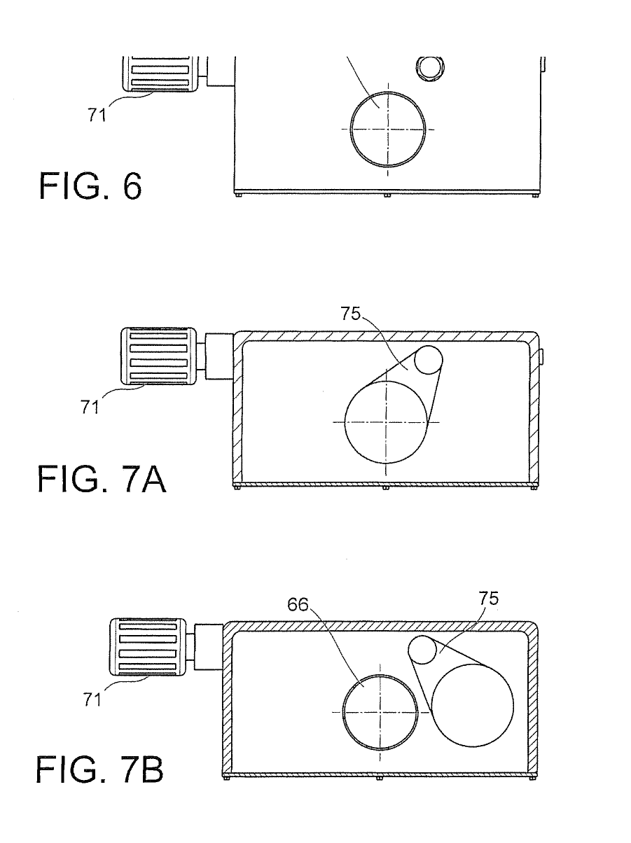

FIG. 6 illustrates a top view of the device of the invention.

FIGS. 7A and 7B illustrate two section views AA of the device of the invention as illustrated in FIG. 5, respectively with a valve to close the upper portion of an outlet chute in a closed position and in an open position.

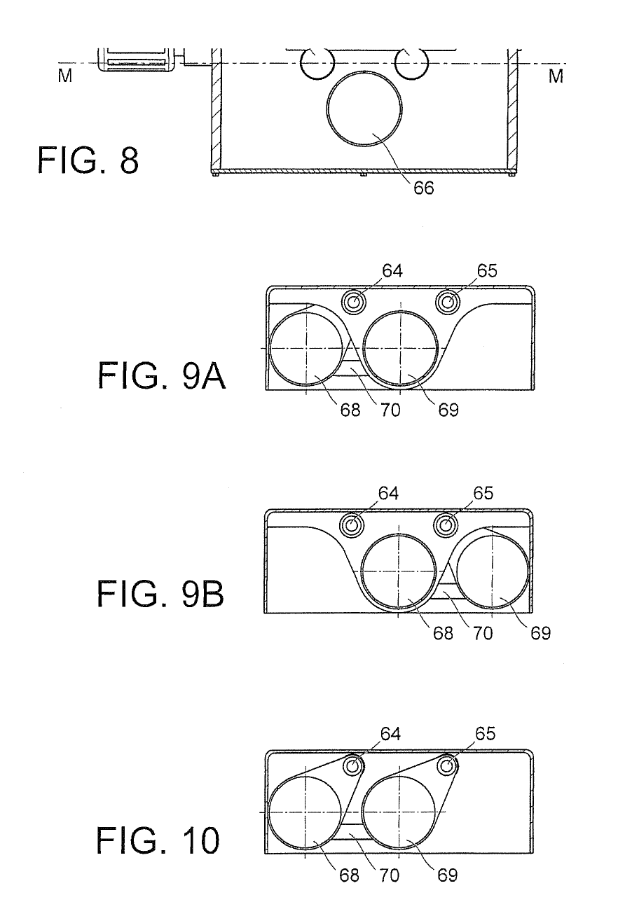

FIG. 8 illustrates a section view BB of the device of the invention as illustrated in FIG. 5.

FIGS. 9A and 9B illustrate two section views CC of the device of the invention as illustrated in FIG. 5, respectively with the two containers in the first position and in a second position.

FIG. 10 illustrates a section view DD of the device of the invention as illustrated in FIG. 5, where both containers are in the first position.

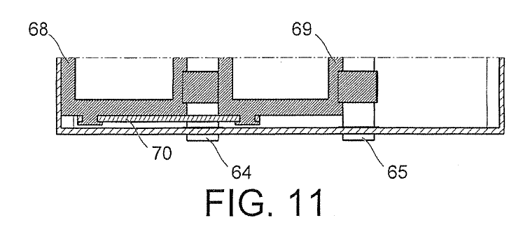

FIG. 11 illustrates a detail F of the device of the invention as illustrated in FIG. 5.

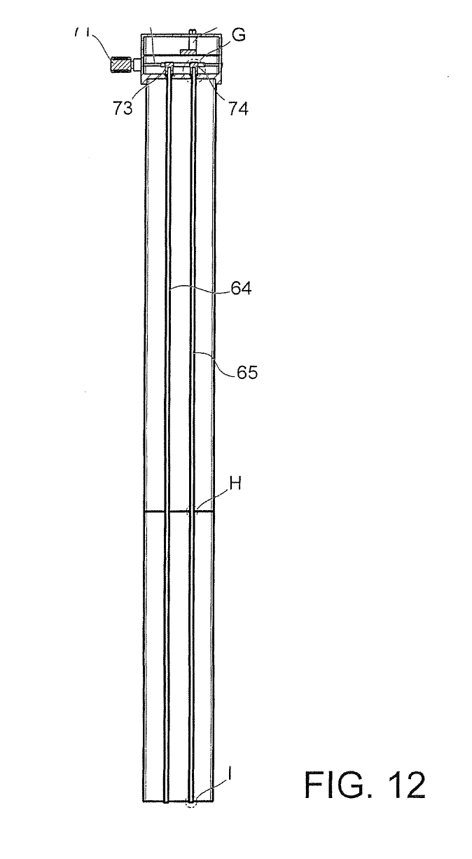

FIG. 12 illustrates a section view MM of the device of the invention as illustrated in FIG. 8.

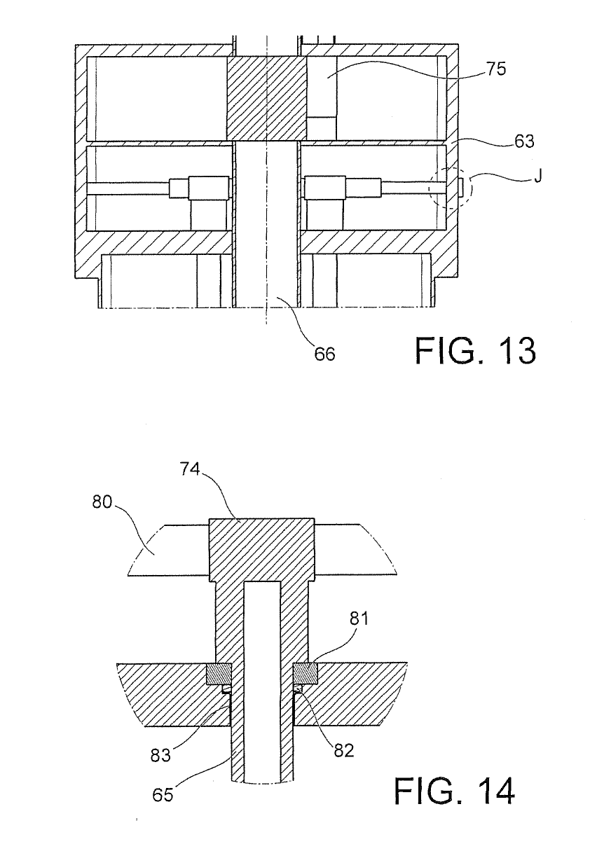

FIG. 13 illustrates the mechanism for controlling the rotation of the two containers.

FIG. 14 illustrates a detail G of FIG. 12 with drive shaft 80, a stepped wheel 74, a bearing 81, a seal 82, a ring 83 and an rotary shaft 65.

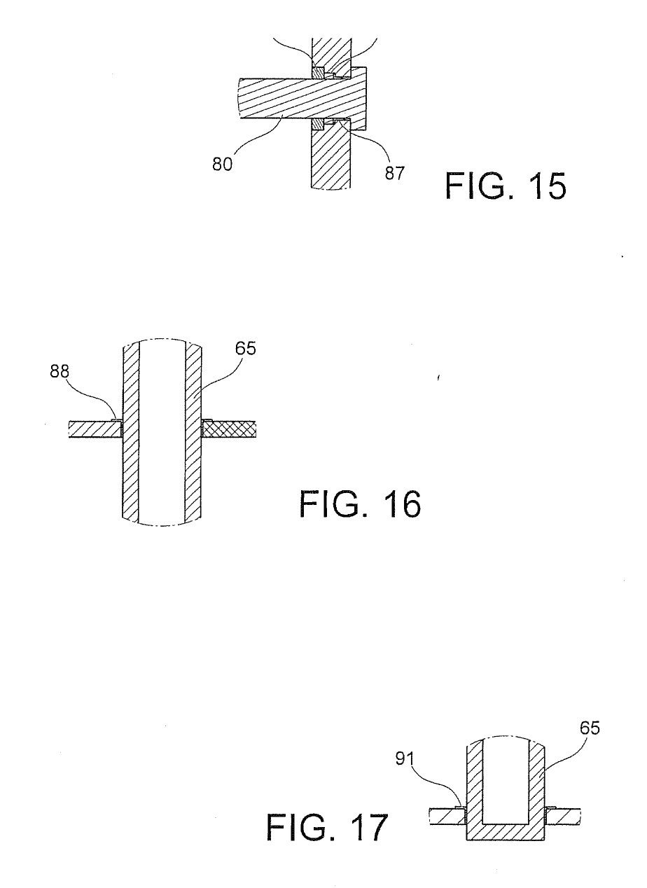

FIG. 15 illustrates a detail J of FIG. 13 with rotor shaft 80, a bearing 85, a seal 86 and a ring 87.

FIG. 16 illustrates a detail H of FIG. 12, with rotary shaft 65 and a ring 88.

FIG. 17 illustrates a detail I of FIG. 12, with a ring 91 and rotary shaft 65.

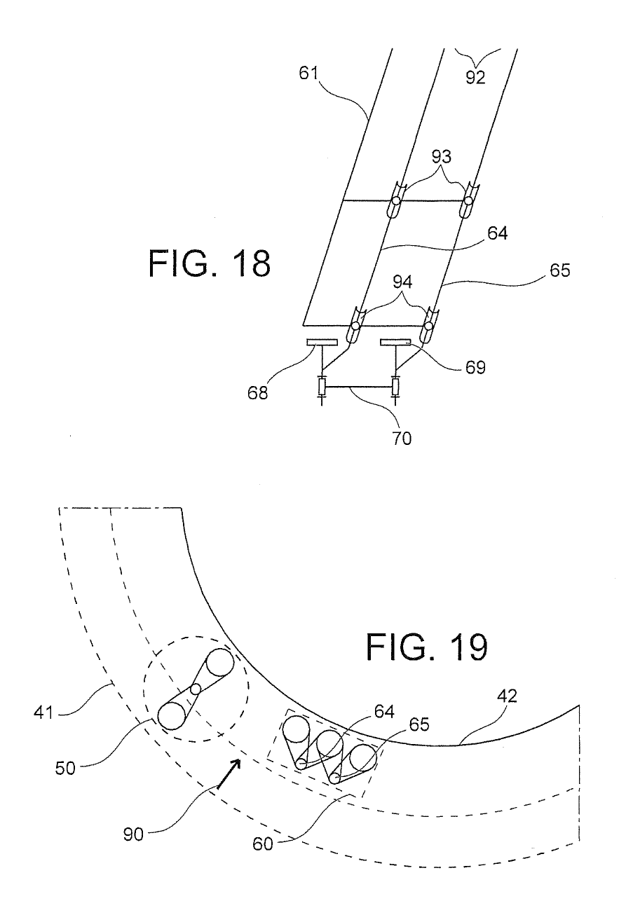

FIG. 18 illustrates the drive line of the device of the invention.

FIG. 19 illustrates the space saving gained by the device of the invention in a nuclear reactor.

### DETAILED ACCOUNT OF PARTICULAR EMBODIMENTS

The invention relates to a device to replace an irradiated, or used, fuel assembly with a new fuel assembly in the vessel of a nuclear reactor. This device includes:
means for installing these two assemblies, one irradiated and one new, in two containers containing heat transfer fluid, where each container has the shape of a closed cylinder, in its lower end, where the first container is filled with the irradiated fuel assembly having just been extracted from the nuclear core by a handling arm and, advantageously, a metal handling rod, and where the second container is filled with the new fuel assembly, brought in by a transfer basket,
means for positioning both these containers by rotating or translating, where the irradiated fuel assembly is placed in a position where it is accessible by the transfer basket, whereas the new fuel assembly is in a position where it can be taken up by the handling arm,
means for positioning these fuel assemblies, where the new fuel assembly is conveyed into the reactor core, whereas the irradiated fuel assembly is conveyed out of the reactor.

The device of the invention includes a double-rotor system 60, as illustrated in FIGS. 4 to 17, which includes:
a single-piece structure formed by a parallelepipedic metal frame 61 of lengthened shape along a vertical axis open on one 62 of its lengthened faces in order that it is accessible by the handling arm, the upper portion of which is surmounted by a sealed case 63;
two rotary shafts 64 and 65, an outlet chute 66, the upper portion of which is split, and two heat transfer fluid containers 68 and 69 in its lower portion 66, connected to one another by a connecting rod 70 in their lower portions, where rotary shafts 64 and 65, outlet chute 66 and heat transfer fluid containers 68 and 69 are positioned parallel to the vertical axis.

The sealed case 63 includes a motor 71 with an endless screw 72, associated with two stepped wheels 73 and 74, each of which is rigidly connected with one of shafts 64 and 65, where each stepped wheel engages with the endless screw, and enables these two shafts to be rotated simultaneously, and a valve 75 to close the upper portion of outlet chute 66.

In the double-rotor device 60 of the invention, rotary shafts 64 and 65 are offset in order to allow coordinated movement of both heat transfer fluid containers 68 and 69, accomplished by single motor 71. Only rotary movements are used. The compactness of the obtained assembly is thus optimised.

The upper portion of the device of the invention illustrated in FIG. 13 constituted by sealed case 63 which encloses the rotation mechanisms, is sealed from the reactor vessel by virtue of seal 82. Both ball-joint connections 92 are then produced by bearings, the lubricants of which may not affect the reactor's heat transfer fluid. In the middle and lower portion, rings 88 and 91 provide the other connections. Both rotating containers 68 and 69 are fixed securely by a connecting rod 70, in order to rigidify the entire mechanism. Outlet chute 66 enables a container 68 or 69 to be guided when extracting an irradiated fuel assembly or bringing in a new fuel assembly, this chute being split along its entire length, to enable the handling arm to access it in the event that the double-rotor device of the invention becomes blocked. The upper portion of this device is lubricated and sealed from the reactor vessel.

The transfer basket may thus dock in the upper portion of the device of the invention, where the seal from this device is accomplished by means of valve 75.

The device and the method of the invention can advantageously be implemented in a sodium heat transfer fluid reactor, where containers 68 and 69 are then sodium containers.

The drive line of the double-rotor device of the invention is illustrated in FIG. 18. The rotation of shafts 64 and 65 is guided by a connection comparable to a ball joint 92 in the upper portion, and two annular linear connections 93 and 94 in the middle and lower portion, by this means allowing shafts 64 and 65 to expand freely in frame 61.

As illustrated in FIG. 19, the device of the invention leads to greater compactness compared to a conventional rotor device 50, and a reduction of the diameter of internal vessel 41, and therefore of main vessel 40. The expected gain (reduction of diameter 90) is approximately 10% for the diameter. In addition, the device of the invention allows the outlet container to be accessible by the handling arm if the double-rotor device of the invention becomes blocked.

### REFERENCE

(1) “Récteurs à neutrons rapides refroidis au sodium” [<<Sodium-Cooled Fast Neutron Reactors>>] by Jean-Paul Cretté (Techniques de l'ingénieur, BN 3170, pages 1-24, 10 Jul. 2005).

1. A device to replace an irradiated fuel assembly with a new fuel assembly in the vessel of a nuclear reactor, which includes:
means for installing two fuel assemblies, one irradiated and one new, in two containers containing heat transfer fluid, where the first container is filled with the irradiated fuel assembly having just been extracted from the reactor core by a handling arm, and where the second container is filled with the new fuel assembly brought in by a transfer basket,
means for positioning both these containers, where the irradiated fuel assembly is placed in a position where it is accessible by the transfer basket, whereas the new fuel assembly is in a position where it can be taken up by the handling arm,
means for positioning the two fuel assemblies, where the new fuel assembly is conveyed into the reactor core, whereas the irradiated fuel assembly is conveyed out of the reactor,
wherein the means for positioning the two containers are means for positioning by rotation with two offset rotary shafts produced by a single motor.

2. A device according to claim 1, which includes a single-piece structure, the upper portion of which is surmounted by a sealed case.

3. A device according to claim 2, in which the single-piece structure includes a parallelepipedic metal frame of lengthened shape open on one of its lengthened faces, both rotary shafts, an outlet chute, the upper portion of which is split, and two containers in its lower portion, connected to one another by a connecting rod in their lower portions.

4. A device according to claim 3, in which the sealed case includes a motor with an endless screw, associated with two stepped wheels, each of which is rigidly connected with one of the two rotary shafts allowing simultaneous rotation of both these shafts.

5. A device according to claim 4, in which the sealed case includes a valve for closing the upper portion of the outlet chute.

6. A device according to claim 1, in which the heat transfer fluid used is sodium-based.

7. A nuclear reactor including a vessel able to be filled with heat transfer fluid, and within which are positioned a core, pumping means to pump the primary heat transfer fluid, first intermediate heat exchangers, able to evacuate the power produced by the core during normal operation, second residual heat exchangers able to evacuate the decay power produced by the core when shut down, when the pumping means are also stopped, and a covering slab, characterised in that it includes a device as claimed in claim 1.

8. A reactor according to claim 7 which is a reactor with sodium heat transfer fluid.

9. A method for replacing an irradiated fuel assembly with a new fuel assembly in the vessel of a nuclear reactor, which includes:
a step of installing two fuel assemblies, one irradiated and one new, in two containers containing heat transfer fluid, where the first container is filled with the irradiated fuel assembly having just been extracted from the reactor core by a handling arm, and where the second container is filled with the new fuel assembly brought in by a handling basket,
a step of positioning both these containers, where the irradiated fuel assembly is placed in a position where it is accessible by the transfer basket, whereas the new fuel assembly is in a position where it can be taken up by the handling arm,
a step of positioning the two fuel assemblies, where the new fuel assembly is conveyed into the reactor core, whereas the irradiated fuel assembly is conveyed out of the reactor,
wherein the step of positioning of the two containers is a step of positioning by rotation with two offset rotational shafts accomplished by a single motor.

10. A method according to claim 9, in which a motor with an endless screw associated with two stepped wheels, each of which is rigidly connected with one of the two rotary shafts, is used.

11. A method according to claim 10, in which an outlet chute and two heat transfer fluid containers connected to one another by connecting rod are used.

12. A method according to claim 11, in which the outlet chute aperture is closed by means of a valve.

13. A method according to claim 9, in which the heat transfer fluid used is sodium.
